(19) United States
(12) Patent Application Publication
(10) Pub. No.: US 2025/0196508 A1
(43) Pub. Date: Jun. 19, 2025

(54) LIQUID EJECTION APPARATUS AND TESTING METHOD

(71) Applicant: CANON KABUSHIKI KAISHA, Tokyo (JP)

(72) Inventor: TAKATSUGU MORIYA, Tokyo (JP)

(21) Appl. No.: 18/967,446

(22) Filed: Dec. 3, 2024

(30) Foreign Application Priority Data
Dec. 14, 2023 (JP) 2023-210889

(51) Int. Cl. B41J 2/18; B41J 2/175

(52) U.S. Cl. CPC B41J 2/18; B41J 2/17596

(57) ABSTRACT

Provided is a liquid ejection apparatus and a testing method capable of detecting whether ink circulation flow is normal, while achieving size reduction and cost reduction. To this end, an ejection operation is performed with an output for a first circulation pump being lowered from an output for regular printing by a printing apparatus, and it is determined based on the result of the ejection operation whether liquid is circulating normally.

### BACKGROUND OF THE INVENTION

### Field of the Invention

The present disclosure relates to a liquid ejection apparatus and a testing method.

### Description of the Related Art

Japanese Patent Laid-Open No. 2020-196164 discloses an inkjet printing apparatus which includes a supply tank, a main tank, and a collection tank and circulates liquid in a liquid ejection head. In the inkjet printing apparatus described in Japanese Patent Laid-Open No. 2020-196164, ink circulation flow during circulation is monitored using a pressure sensor, and in a case where the ink circulation flow is improper, an output for a pump is adjusted based on the pressure sensor to achieve proper ink circulation flow.

However, a configuration where the pressure sensor is in a circulation path has a problem in that it is difficult to reduce the size and cost of the liquid ejection head or the inkjet printing apparatus.

### SUMMARY OF THE INVENTION

Thus, the present disclosure provides a liquid ejection apparatus and a testing method capable of detecting whether ink circulation flow is normal, while achieving size reduction and cost reduction.

To this end, a liquid ejection apparatus of the present disclosure includes: a print unit that performs printing by ejecting liquid from an ejection port; a pump that circulates the liquid to be supplied to the ejection port; and a control unit that controls driving of the print unit and the pump. In a print operation for printing an image on a print medium, the control unit drives the pump using a first output, and in circulation testing for testing a circulation state of the liquid, the control unit drives the pump using a second output with which a smaller amount of liquid is delivered than with the first output.

The present disclosure can provide a liquid ejection apparatus and a testing method capable of detecting whether ink circulation flow is normal, while achieving size reduction and cost reduction.

Further features of the present invention will become apparent from the following description of exemplary embodiments with reference to the attached drawings.

### BRIEF DESCRIPTION OF THE DRAWINGS

FIGS. 1A and 1B are schematic diagrams showing a printing apparatus having a liquid ejection head;

FIGS. 2A, 2B, and 2C are diagrams showing a print element substrate;

FIG. 3 is a block diagram showing the configuration of the printing apparatus;

FIG. 4 is a flowchart showing circulation testing processing for detecting a circulation state;

FIGS. 5A and 5B are diagrams showing a test pattern;

FIG. 6 is a graph showing the relation between circulation flow speed and pump output;

FIG. 7 is a flowchart showing circulation testing processing;

FIG. 8 is a diagram illustrating how a droplet is detected using a sensor;

FIGS. 9A and 9B are a sectional view and a plan view showing example configurations of a heater and a temperature detection element;

FIG. 10 is a diagram showing temperature profiles for a normal ejection state and a non-ejection state;

FIG. 11 is a flowchart showing circulation testing processing; and

FIG. 12 is a graph showing the relation between circulation flow speed and pump output.

### DESCRIPTION OF THE EMBODIMENTS

### First Embodiment

A first embodiment of the present disclosure is described below with reference to the drawings. The following describes a liquid ejection apparatus, taking a printing apparatus employing an inkjet printing method as an example. The printing apparatus may be, for example, a single-function printer only having a printing function or a multi-function printer having a plurality of functions such as a printing function, a FAX function, and a scanner function. The printing apparatus may also be a manufacturing apparatus that uses a predetermined printing method to manufacture color filters, electronic devices, optical devices, or minute structures.

Note that “printing” in the following description is not limited to forming meaningful information such as text and graphics, and it does not matter whether the information is meaningful or meaningless. “Printing” does not necessarily only mean forming information actualized so that humans can visually perceive it, and also refers to forming an image, a design, a pattern, a structure, or the like widely on a print medium or processing a medium.

Also, a “print medium” is not only paper used in typical printing apparatuses, but also a medium that can receive ink, such as fabric, a plastic film, a metal plate, glass, ceramics, resin, wood, leather, or the like.

Further, “ink” should be interpreted broadly, as is similar to the definition of “printing” above. Thus, “ink” refers to liquid that can be used to, by being applied onto a print medium, form an image, a design, a pattern, or the like on the print medium, process the print medium, or treat ink (e.g., solidifying or insolubilizing a color material in ink applied to a print medium).

Further, a “print element” (also referred to as a “nozzle”) is, unless otherwise noted, a collective term for an ink ejection port or a flow channel communicating therewith and an element that generates energy used for ink ejection (an ejection element).

There are two types of a printing apparatus: a serial type that performs printing by moving the liquid ejection head and a print medium alternately and a line type that performs printing by conveying a print medium with the liquid ejection head fixed. The present embodiment can be applied to both of a serial-type printing apparatus and a line-type printing apparatus.

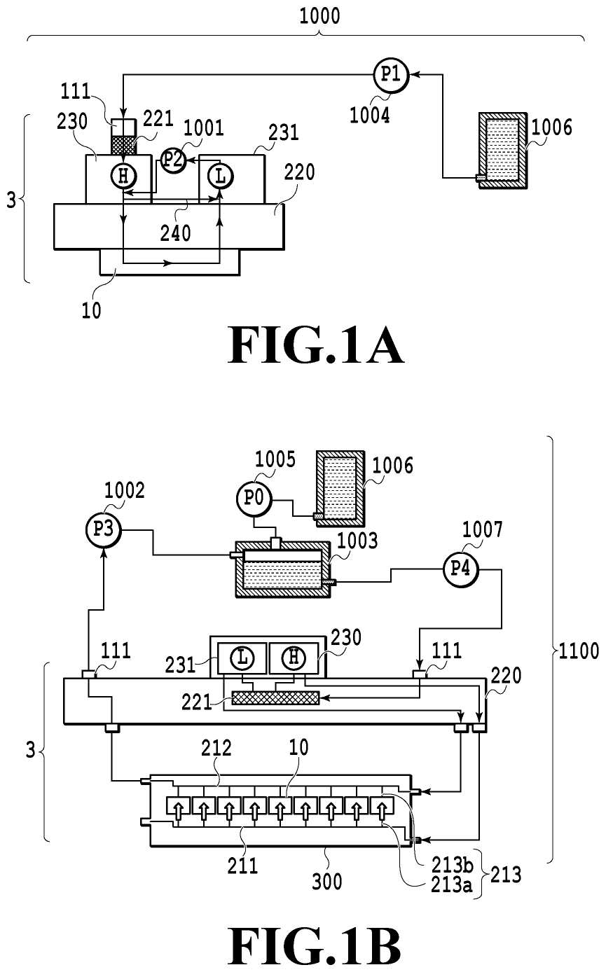

FIG. 1A is a schematic diagram showing a printing apparatus 1000 having a serial-type head, to which the present embodiment can be applied. The printing apparatus 1000 supplies liquid in a main tank 1006 to a liquid connection unit 111 of a liquid ejection head 3 via a pump 1004. Ink that has passed the liquid connection unit 111 passes through a filter 221, travels through a high-pressure-side negative pressure control unit 230 (denoted as H in FIGS. 1A and 1B), fluidically communicates with a liquid supply unit 220, and is supplied to a print element substrate 10 where nozzles are formed. While part of the ink supplied to the print element substrate 10 is ejected from the nozzles, ink not ejected travels back through a discharge flow channel in the liquid supply unit 220 and arrives at a low-pressure-side negative pressure control unit 231 (denotes as Lin FIGS. 1A and 1B). Ink circulates in the liquid ejection head 3 due to a difference in pressure between the high-pressure-side negative pressure control unit 230 and the low-pressure-side negative pressure control unit 231.

The printing apparatus 1000 further includes a pump 1001 that delivers the ink in the low-pressure-side negative pressure control unit 231 back to the high-pressure-side negative pressure control unit 230, and thus can circulate ink by driving the pump 1001 as well. The pump 1001 is integral with the liquid ejection head 3 and is desirably compact and lightweight so as not to impair the scanning operation of the liquid ejection head 3. Preferably, the pump 1001 is, for example, a compact diaphragm or piezoelectric pump.

In a case where an output for the pump 1001 is large and the amount of ink delivered back to the high-pressure-side negative pressure control unit 230 is larger than the amount of ink flowing into the print element substrate 10, a bypass flow channel 240 is used to compensate for the deficit of ink. A backflow prevention valve (not shown) is disposed at the bypass flow channel 240, and ink flows only in the direction from the high-pressure-side negative pressure control unit 230 to the low-pressure-side negative pressure control unit 231.

FIG. 1B is a schematic diagram showing a printing apparatus 1100 having a line-type head, to which the present embodiment can be applied. Note that common members in FIGS. 1A and 1B are denoted by the same reference numerals. In the printing apparatus 1100, a main tank 1006 is connected to a buffer tank 1003 via a refill pump 1005, and the buffer tank 1003 has an atmosphere communication port (not shown) that allows the inside and outside of the tank to communicate and discharge air bubbles in ink to the outside. In the event where the liquid ejection head 3 has consumed liquid by ejecting (discharging) ink from ejection ports of the liquid ejection head 3 in an operation that involves ink ejection, such as printing or suction recovery, the refill pump 1005 transfers ink from the main tank 1006 to the buffer tank 1003 to compensate for the amount of ink consumed.

A first circulation pump 1002 draws ink from a liquid connection unit 111 of the liquid ejection head 3 and passes the ink to the buffer tank 1003. A displacement pump capable of delivering liquid quantitatively is preferable as the first circulation pump 1002. Specific examples include a tube pump, a gear pump, a diaphragm pump, and a syringe pump, but for example, a typical constant flow valve or relief valve may be disposed at the exit of a pump to obtain a constant flow amount. While the liquid ejection head 3 is driven, the first circulation pump 1002 causes a fixed amount of ink to flow through a common supply flow channel 211 and a common collection flow channel 212.

A difference in temperature between print element substrates 10 in the liquid ejection head 3 affects the adjacent print element substrates 10 and consequently affects print quality. Thus, the flow amount is preferably set to a value such that a difference in temperature between the print element substrates 10 will not affect the adjacent print element substrates 10. Also, setting too large a flow amount may cause image density unevenness because differences in negative pressure between the print element substrates 10 become too large due to pressure loss in the flow channels in a liquid ejection unit 300. It is therefore preferable to set the flow amount considering differences in temperature and negative pressure between the print element substrates 10.

Negative pressure control units 230, 231 are provided on a path between a second circulation pump 1007 and the liquid ejection unit 300. The negative pressure control units 230, 231 maintain pressure downstream of the negative pressure control units 230, 231 (i.e., on the liquid ejection unit 300 side) at a preset fixed pressure even in a case where the flow amount in the circulation system fluctuates due to a difference in print coverage in printing. Any mechanisms may be used as two pressure adjustment mechanisms forming the negative pressure control units 230, 231 as long as they can control the pressure downstream thereof within a range of fluctuation from a desired set pressure.

For example, a mechanism similar to what is called a “pressure-reducing regulator” may be used as the pressure adjustment mechanisms. In a case of using a pressure-reducing regulator, it is preferable that, as shown in FIG. 1B, the second circulation pump 1007 be used to increase the pressure upstream of the negative pressure control units 230, 231 via the liquid supply unit 220. This helps reduce the influence of hydraulic head pressure of the buffer tank 1003 on the liquid ejection head 3, making it possible to increase the layout flexibility for the buffer tank 1003 in the printing apparatus 1000.

Any pump may be used as the second circulation pump 1007 as long as the pump has a certain lift pressure or higher within a range of ink circulation flow amount used while the liquid ejection head 3 is driven, and a turbo pump, a displacement pump, or the like can be used. Specifically, a diaphragm pump or the like can be employed. Also, in place of the second circulation pump 1007, for example, a hydraulic head tank disposed to have a certain hydraulic head difference relative to the negative pressure control unit 230 can be employed.

As shown in FIG. 1B, the negative pressure control units 230, 231 are two pressure adjustment mechanisms having different settings of control pressure from each other. Of the two negative pressure adjustment mechanisms, the negative pressure control unit 230 set to relatively high pressure and the negative pressure control unit 231 set to relatively low pressure are respectively connected to the common supply flow channel 211 and the common collection flow channel 212 in the liquid ejection unit 300 through the inside of the liquid supply unit 220.

The liquid ejection unit 300 is provided with the common supply flow channel 211, the common collection flow channel 212, and individual supply flow channels 213a and individual collection flow channels 213b both communicating with the respective print element substrates 10. The individual flow channels 213 communicate with the common supply flow channel 211 or the common collection flow channel 212, and part of the liquid from the common supply flow channel 211 passes through the internal flow channels in the print element substrate 10 and flows to the common collection flow channel 212 (the arrows in FIG. 1B). The high-pressure-side negative pressure control unit 230 is connected to the common supply flow channel 211, and the low-pressure-side negative pressure control unit 231 is connected to the common collection flow channel 212. Thus, a difference in pressure is generated between the common supply flow channel 211 and the common collection flow channel 212.

In this way, in the liquid ejection unit 300, while the liquid flows through the common supply flow channel 211 and the common collection flow channel 212, part of the liquid passes through each of the print element substrates 10. In this way, heat generated by each print element substrate 10 is discharged to the outside of the print element substrate 10 by the flow through the common supply flow channel 211 and the common collection flow channel 212.

In this way, while the liquid ejection head 3 is performing printing, ink flows also through the ejection ports and pressure chambers that are not used for the printing, which helps reduce thickening of ink in the ejection ports and pressure chambers that are not being used for the printing. This enables high speed, high quality printing.

Although the present embodiment can be applied to both of the printing apparatus 1000 having a serial-type head shown in FIG. 1A and the printing apparatus 1100 having a line-type head shown in FIG. 1B, the following description takes the printing apparatus 1100 having a line-type head as an example.

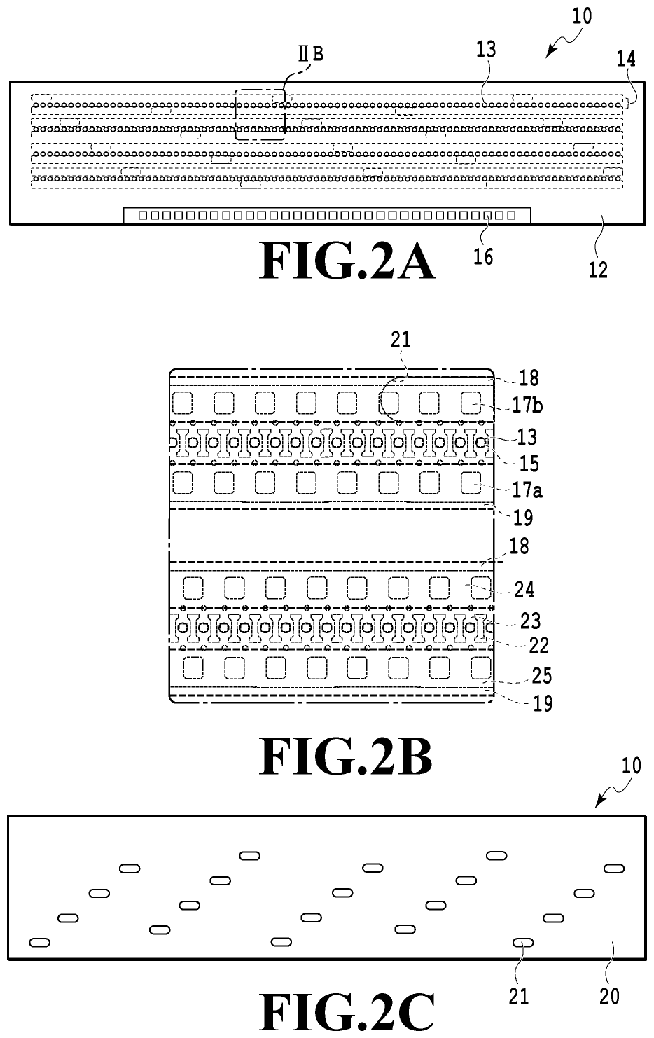

FIGS. 2A to 2C are diagrams showing the print element substrate 10.

FIG. 2A is a plan view of the print element substrate 10 showing its ejection port formation member 12 side where ejection ports 13 are formed, FIG. 2B is an enlarged view showing a part in FIG. 2A denoted by IIb, and FIG. 2C is a plan view of a lid member 20, which is the back side of FIG. 2A. The print element substrate 10 includes a substrate (not shown), the ejection port formation member 12, and the lid member 20, and the lid member 20 is provided at the opposite side of the substrate from the ejection port formation member 12.

As shown in FIG. 2A, four ejection port arrays 14 corresponding to the respective ink colors are formed at the ejection port formation member 12 of the print element substrate 10. Note that the direction in which the ejection port arrays 14, each being an array of a plurality of ejection ports 13, extend is hereinafter referred to as an “ejection port array direction.”

As shown in FIG. 2B, a heater 15 is disposed at a position corresponding to each ejection port 13. The heater 15 is a heat generation element that generates a bubble in ink using heat energy. Pressure chambers 23 having the heaters 15 inside are defined by partitioning walls 22. The heaters 15 are electrically connected to terminals 16 in FIG. 2A by electric wiring (not shown) provided at the print element substrate 10.

The heater 15 generates heat based on a pulse signal inputted from a control circuit in the printing apparatus 1100 via an electric wiring substrate (not shown) and a flexible wiring substrate (not shown) and boils ink. The force of a bubble generated by the boiling is used to eject ink from the ejection port 13. As shown in FIG. 2B, a liquid supply channel 18 and a liquid collection channel 19 extend along each ejection port array 14 and communicate with the ejection ports 13 via supply ports 17a and collection ports 17b, respectively.

As shown in FIG. 2C, the lid member 20 in sheet form is laminated at the back surface of the print element substrate 10, which is opposite from the surface where the ejection ports 13 are formed, and the lid member 20 is provided with a plurality of openings 21 communicating with the liquid supply channel 18 and the liquid collection channel 19. In the present embodiment, three openings 21 are provided for every liquid supply channel 18, and two openings 21 are provided for every liquid collection channel 19. The lid member 20 functions as a lid that forms part of the walls of the liquid supply channel 18 and the liquid collection channel 19 formed in the substrate of the print element substrate 10.

The lid member 20 is preferably formed of a member having enough corrosion resistance with respect to ink, and from the perspective of preventing mixing of colors, high precision is required in terms of the shapes and positions of the openings 21. For this reason, it is preferable that a photosensitive resin material or a silicon plate be used as a material for the lid member 20 and that the openings 21 be provided photolithographically. Considering pressure loss, such a lid member 20 is desirably thin and is preferably formed of a film-shaped member.

Next, the flow of ink in the print element substrate 10 is described. In the print element substrate 10, the ejection port formation member 12 formed of a photosensitive resin is laminated on a substrate formed of Si, and the lid member 20 is joined to the back surface of the substate. The heaters 15 are formed at a one surface side of the substrate, and grooves constituting the liquid supply channels 18 and the liquid collection channels 19 are formed at the other surface side of the substate, extending along the ejection port arrays 14.

Ink flows from a common supply flow channel (not shown) in the liquid supply unit 220 into each liquid supply channel 18 via the openings 21 in the lid member 20 and flows into the pressure chambers 23 through the supply ports 17a and a supply-side common liquid chamber 25 in the ejection port formation member 12. In the pressure chambers 23, part of the ink is ejected from the ejection ports 13, and ink not ejected flows into the liquid collection channel 19 through a collection-side common liquid chamber 24 and the collection ports 17b. Ink in the liquid collection channel 19 flows to a common collection flow channel (not shown) in the liquid supply unit 220 through the openings 21 in the lid member 20.

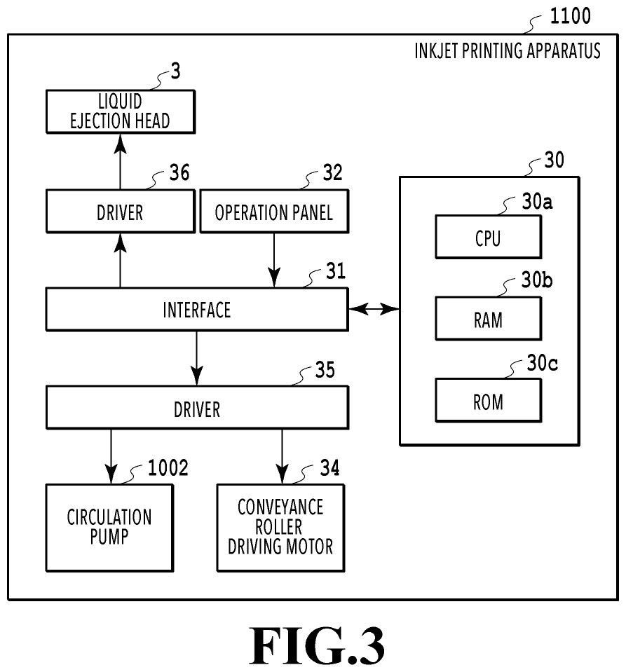

FIG. 3 is a block diagram showing the configuration of the printing apparatus 1100. The printing apparatus 1100 includes a control unit 30 having a CPU 30a such as a microprocessor and a RAM 30b which is used as a work area by the CPU 30a and which, e.g., stores various kinds of data such as print data and registration adjustment values. The control unit 30 also includes a ROM 30c that stores control programs for the CPU 30a and various kinds of data. The printing apparatus 1100 further includes an interface 31, an operation panel 32, and drivers 35, 36. The driver 35 drives and controls a motor 34 for driving a conveyance roller and a circulation pump 1002 on the supply flow channel, and the driver 36 drives the liquid ejection head 3.

Print data received by the printing apparatus 1100 is stored in the RAM 30b of the control unit 30. According to the print data stored in the RAM 30b, the control unit 30 outputs ON/OFF signals for driving the motor 34 to the driver 35 and ejection signals and the like to the driver 36 to form an image on a print medium. The control unit 30 also controls the circulation pump 1002 by outputting a signal for driving the circulation pump 1002 to the driver 35 in accordance with a control sequence to be described later.

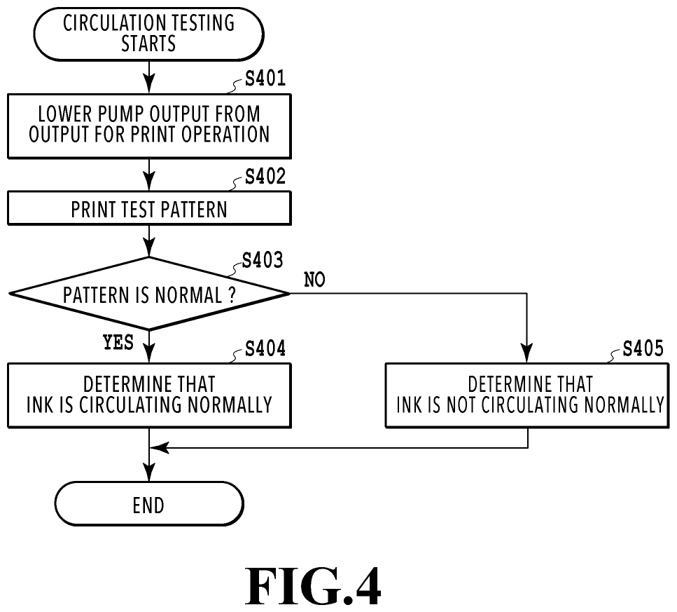

FIG. 4 is a flowchart showing circulation testing processing, which is testing performed to detect whether ink circulation is normal (a circulation state) beforehand. The series processing steps shown in FIG. 4 are performed by the CPU 30a of the printing apparatus 1100 by loading program code stored in the ROM 30c into the RAM 30b and executing the program code. Alternatively, some or all of the functions in the steps in FIG. 4 may be implemented by hardware such as an ASIC or an electronic circuit. Note that the letter “S” in the description of each processing means that it is a step in the flowchart.

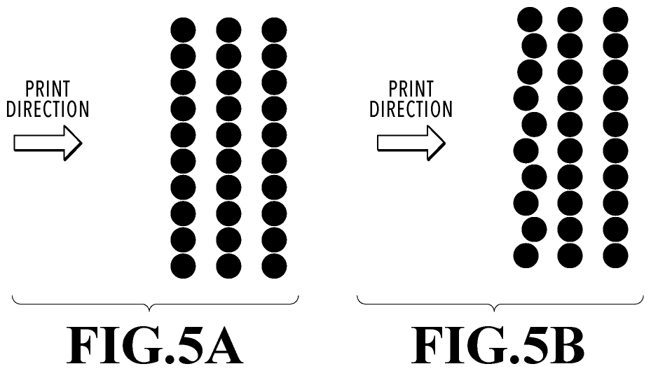

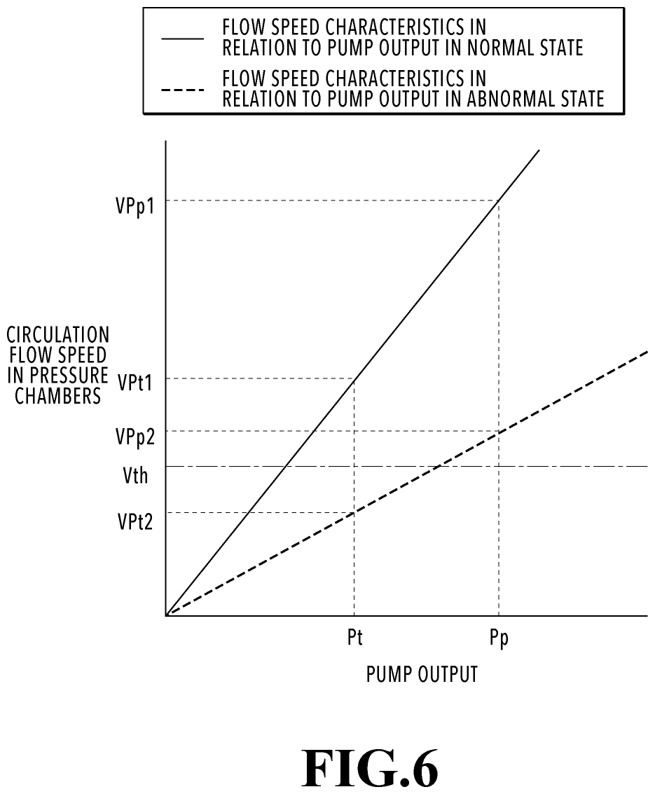

FIG. 5A is a diagram showing a testing pattern printed in circulation testing with ink circulating normally, and FIG. 5B is a diagram showing a testing pattern printed in circulation testing with ink not circulating normally. FIG. 6 is a graph showing the relation between circulation flow speed and pump output for normal circulation state and abnormal circulation state.

In the present embodiment, circulation testing is performed to detect whether ink flowing in the ejection ports 13 and the pressure chambers 23 is circulating normally. In the circulation testing, a testing pattern is printed and checked to determine whether ink is circulating normally. In a case where ink is circulating normally, the testing pattern is printed as shown in FIG. 5A. By contrast, in a case where ink is not circulating normally, the testing pattern is printed as shown in FIG. 5B. Note that the black dots in FIGS. 5A and 5B indicate dots formed by droplets ejected from the ejection ports 13 and landing on a print medium.

In the present embodiment, the circulation testing is conducted with an output for the first circulation pump 1002 being lowered from the output used in regular printing by the printing apparatus 1100. Lowering the output for the first circulation pump 1002 decreases the amount of liquid delivered and therefore lowers the circulation amount of ink flowing in the ejection ports 13 and the pressure chambers 23. The testing pattern is printed with the ink circulation amount being thus lowered. With a proper ink circulation amount, dots are printed at desired positions from the first ejection after a long halt, as shown in FIG. 5A. By contrast, with less ink circulation amount, dots are printed off the desired positions in the first ejection after a long halt, as shown in FIG. 5B. Ejected droplets are off the desired positions because ink was not circulating normally during the long halt due to pump deterioration or the like, which has increased the viscosity of the ink near the ejection ports 13, delaying the timing of the first ejection.

Note that in a case where the pump is, for example, a tube pump, the output for the pump corresponds to the number of revolutions of a roller that presses the tube of the tube pump to deliver liquid, and in a case where the motor for driving the tube pump is a DC motor, corresponds to a driving voltage. Also, in a case where the pump is a piezoelectric pump, the output for the pump corresponds to a drive frequency or voltage for the piezoelectric element for liquid delivery, and changing the driving frequency or voltage can change the amount of liquid delivered per unit time. In this way, an output is a parameter for changing the amount of ink delivered.

Once the circulation testing shown in FIG. 4 starts, in S401, the CPU 30a lowers an output for the first circulation pump 1002 from an output Pp for regular printing by the printing apparatus 1100 to an output Pt for testing, which is lower than the output Pp. In S402, with the output for the first circulation pump 1002 being lowered, the CPU 30a performs control to print a test pattern. After that, in S403 (a determination unit), the CPU 30a determines whether the printed test pattern is normal. If determining that the printed test pattern is normal (YES), the CPU 30a proceeds to S404 and determines that the ink is circulating normally. If determining that the printed test pattern is not normal (NO), the CPU 30a proceeds to S405 and determines that the ink is not circulating normally. The present processing thus ends.

In a case where the ink is circulating normally, as indicated by the solid line in FIG. 6, the circulation flow speed in the pressure chambers 23 is VPp1 at the pump output Pp for regular printing and is VPt1 at the pump output Pt for circulation testing. Here, Vth is a minimum circulation flow speed in the pressure chambers 23 for achieving a desired ejection operation. In a case where ink is circulating normally, circulation flow exceeding the threshold Vth is achieved at both of the pump output Pp and the pump output Pt, and no ejection failure occurs.

By contrast, in a case where ink is not circulating normally for some reason, the pump output and the circulation flow speed in the pressure chambers have a relation as indicated with the dotted line in FIG. 6, for example. In this case, at the pump output Pp for regular printing, the circulation flow speed in the pressure chambers 23 is VPp2, which is above the threshold Vth. Meanwhile, at the pump output Pt for circulation testing, the circulation flow speed in the pressure chambers 23 is VPt2, which is below the threshold Vth. In other words, in a case where ink is not circulating normally, even if no ejection failure is confirmed in actual printing operation, lowering the pump output to the pump output Pt for circulation testing causes the circulation flow speed to fall below the threshold Vth, and an ejection failure is confirmed.

In a case where ink is circulating normally (the solid line in FIG. 6), even with the pump output lowered to Pt, the circulation flow speed is VPt1 and is still faster than Vth. In other words, VPp1>VPt1≥Vth. By contrast, in a case where ink is not circulating normally (the broken line in FIG. 6), at the pump output Pp for regular printing, the circulation flow speed is VPp2 and is faster than Vth (VPp1≥Vth). However, in a case where the circulation testing is performed with the pump output lowered to Pt, the circulation flow speed is VPt2, which is slower than Vth (VPt2<Vth), and a desired print result cannot be obtained.

In the above-described state where ink is not circulating normally, a favorable print result is obtained during regular printing; thus, it cannot be determined whether ink is circulating normally. However, by performing circulation testing with the pump output lowered, printing a test pattern results in a print failure in a state where ink is not circulating normally. Thus, it can be determined that ink is not circulating normally.

The present embodiment can thus determine whether ink is circulating normally by performing circulation testing with the pump output being lowered. Upon detecting that ink is not circulating normally, first, a recovery operation, such as suctioning ink out of the liquid ejection head 3 through the ejection ports 13, is performed as an attempt to remove bubbles or foreign matters in the ejection ports and the flow channels and to resolve thickening of the ink. In a case where such a recovery operation does not resolve the ink circulation abnormality, conceivable causes include the pump being deteriorated and the flow channels in the liquid ejection head 3 being close to a clogged state impossible to resolve. Thus, an operation is performed to, e.g., prompt a user to replace the first circulation pump 1002 or replace the liquid ejection head 3.

The closer the values of the outputs Pp and Pt for the first circulation pump 1002 are to each other, the less frequent the recovery operation or the replacement of the first circulation pump 1002 or the liquid ejection head 3 is, which is more convenient. However, in a case where the values of the outputs Pp and Pt are too close, there is a possibility of erroneous detection due to fluctuations of circulation flow speed or a possibility of ink circulation degrading during a print operation before the next circulation testing, leading to a failure. Also, in a case where the values of the outputs Pp and Pt are too away from each other, an ink circulation failure is determined so easily as to increase the frequency of the recovery operation and the frequency of the replacement of the first circulation pump 1002 and the liquid ejection head 3, which is a disadvantage in terms of convenience and cost. Thus, it is desirable that Pp and Pt have the following relation: 0.5Pp≤Pt≤0.95Pp. Thus, the pump output Pt for circulation testing is preferably set to a value such that an amount of liquid delivered with the pump output Pt for circulation testing may be 0.5 times to 0.95 times an amount of liquid delivered with the pump output Pp for regular printing in normal circulation.

Also, in the present embodiment, in S403 in FIG. 4, it is determined based on a print result of a test pattern whether ink is circulating normally. For this determination on the print result, the printing apparatus 1100 may receive a visual determination from a user or may make the determination by reading the test pattern using a scanner (a read unit) in the printing apparatus 1100 and performing image processing.

In this way, the present embodiment determines whether ink is circulating normally based on a result of ejection operation performed with the output for the first circulation pump 1002 being lowered from the output for regular printing by the printing apparatus 1100. Thus, no pressure sensor needs to be provided in the circulation path. Thus, the present embodiment can provide a liquid ejection apparatus and a testing method capable of detecting whether ink circulation flow is normal, while achieving size reduction and cost reduction.

### Second Embodiment

A second embodiment of the present disclosure is described below with reference to the drawings. Note that the following describes configurations characteristic to the present embodiment because the present embodiment has the same basic configuration as the first embodiment.

In the first embodiment, normality of ink circulation is determined based on a test pattern printed on a print medium. In the present embodiment, normality of ink circulation is determined by not printing a test pattern on a print medium, but by driving the heaters 15 and detecting an ink ejection state.

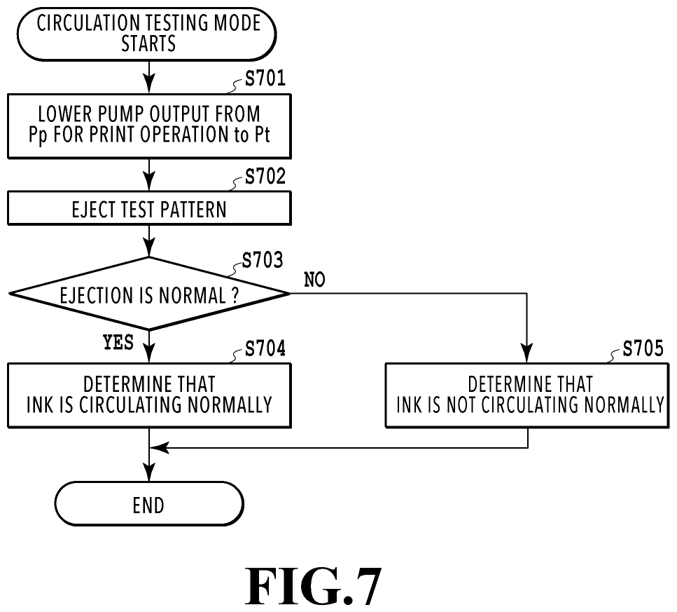

FIG. 7 is a flowchart showing circulation testing processing of the present embodiment. The series of processing steps shown in FIG. 7 are performed by the CPU 30a of the printing apparatus 1100 by loading program code stored in the ROM 30c into the RAM 30b and executing the program code. Alternatively, some or all of the functions in the steps in FIG. 7 may be implemented by hardware such as an ASIC or an electronic circuit. Note that the letter “S” in the description of each processing means that it is a step in the flowchart.

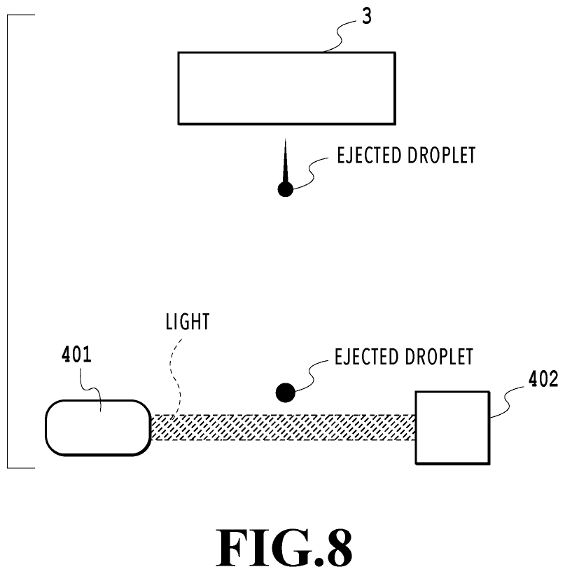

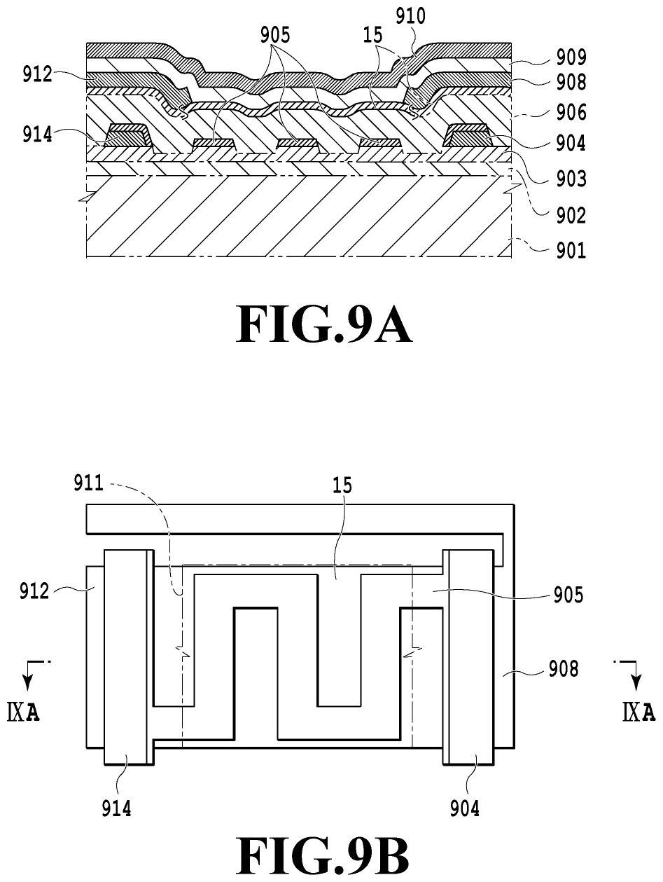

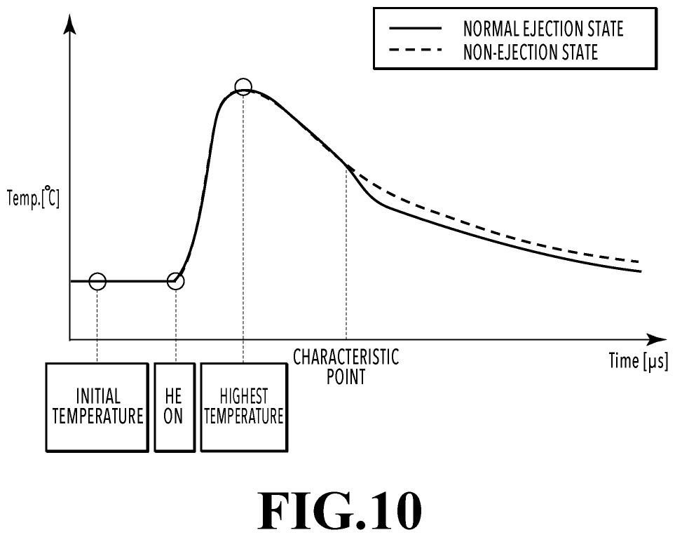

FIG. 8 is a diagram illustrating how a droplet is detected by a sensor in the present embodiment. FIG. 9A is a sectional view showing example configurations of the heater 15 and a temperature detection element 905 formed in the print element substrate 10, and FIG. 9B is a plan view showing example configurations of the heaters 15 and the temperature detection element 905. Note that FIG. 9A is a sectional view taken along IXa-IXa in FIG. 9B, and FIG. 9B is a see-through view showing the positional relation of the temperature detection element 905, seen from the Si substrate 901 side. For the sake of convenience, FIGS. 9A and 9B omit nozzle parts such as the ejection ports 13 and some films. FIG. 10 is a diagram showing temperature profiles for a normal ejection state and a non-ejection state obtained by the temperature detection element 905 upon application of a drive voltage to the heater 15.

In the present embodiment, in circulation testing, an output for the first circulation pump (hereinafter also referred to simply as a pump) 1002 is lowered like in the first embodiment. With an output for the pump 1002 lowered, ink is ejected based on a test pattern, and ejected droplets are detected by an additionally provided sensor to determine whether the droplets are ejected normally (an ejection state). For example, an optical sensor like the one shown in FIG. 8 can be used as the sensor. As shown in FIG. 8, a light source 401 and an optical sensor 402 are disposed at a location in the printing apparatus 1100 toward which ink ejected from the liquid ejection head 3 is directed, and light emitted from the light source 401 is received by the optical sensor 402. Then, as a droplet ejected from the liquid ejection head 3 passes between the light source 401 and the optical sensor 402, the light received by the optical sensor 402 is blocked. Ejection can be detected by detection of this blockage of light. More specifically, it can be determined whether ink is circulating normally based on, e.g., the timing of driving of the heater 15 and the timing of detection of the blockage of light by the optical sensor 402.

Further, detecting the time length of the blockage of light and using a plurality of light sources 401 and a plurality of optical sensors 402 make it possible to detect the ejection speed and the volume of the ejected droplet. This can improve the accuracy of the determination as to whether ink is being ejected normally.

Once the circulation testing shown in FIG. 7 starts, in S701, the CPU 30a lowers an output for the pump 1002 to a value which is lower than the output for regular printing by the printing apparatus 1100. With the output of the pump 1002 being lowered, in S702, the CPU 30a performs control to eject ink droplets based on a test pattern. After that, in S703, the CPU 30a determines, using the optical sensor, whether the ink droplets were ejected normally at the timing of the ejection of the ink droplets in S702. If it is determined that the ink droplets were ejected normally (YES), the CPU 30a proceeds to S704 and determines that ink is circulating normally. If it is determined that the ink droplets were not ejected normally (NO), the CPU 30a proceeds to S705 and determines that ink is not circulating normally. The present processing thus ends.

In the ejection of the example described above, ink droplets are ejected based on a test pattern. However, the present disclosure is not limited to this, and ink droplets may be simply ejected not based on a test pattern.

Also, as a different example of the determination method in S703, a temperature detection element may be incorporated in the print element substrate 10 of the liquid ejection head 3 and used. As shown in FIG. 9A, in the print element substrate 10, a plurality of layers are formed on the Si substrate 901. Specifically, an insulating film PSG 903 is formed on the Si substrate 901 with a field oxide film 902 such as SiO₂ interposed in between. Provided on the insulating film PSG 903 are the temperature detection element 905 formed of a thin-film resistor of Al, Pt, Ti, Ta or the like and AL1 wiring 904 that interconnects the temperature detection elements 905. Further, an interlayer insulating film 906 of SiO or the like is provided as an upper layer, and provided on the interlayer insulating film 906 are the heater 15 of TaSiN or the like that performs electrothermal conversion and AL2 wiring 908 that connects the heater 15 to a drive circuit formed at the Si substrate 901. Provided in addition to these are a passivation film 909 of SiO₂ or the like and an anti-cavitation film 910 of Ta, Ir, or the like that improves the anti-cavitation performance above the heater 15.

As shown in FIG. 9B, the plan view of the print element substrate 10 has a region 911 of the heater 15, a region for AL2 wiring 912 that connects the heater 15 and the drive circuit, and a region for AL1 wiring 914 as an individual interconnection for the temperature detection element 905. Such a configuration of the print element substrate 10 is formed by a semiconductor process. The print element substrate 10 according to the present embodiment can be fabricated through film formation and patterning with the temperature detection element 905 being placed on the AL1 layer and can therefore be fabricated without changing the structure of a conventional print element substrate.

Although meandering in a zigzag manner in FIG. 9A, the temperature detection element 905 is not limited to this shape. The temperature detection element 905 may be formed in, for example, a rectangular shape. In a case where the temperature detection element 905 has a zigzag shape as shown in FIG. 9B, the larger the resistance value of the temperature detection element 905, the larger a detection signal becomes. Thus, a temperature change can be advantageously detected with high precision.

As shown with the temperature profiles in FIG. 10, in a state of normal ejection operation, the temperature detected by the temperature detection element 905 drastically drops after reaching the highest temperature, appearing as a characteristic point (the solid-line graph), whereas in a state of non-ejection, such a characteristic point does not appear (the dotted-line graph). The reason for the temperature drop in the normal ejection operation is as follows. In ejection of ink from the ejection port 13 by driving of the heater 15, the volume of an air bubble generated by film boiling above the heater 15 contracts after reaching its maximum volume. In the process of this contraction, a force is exerted to pull the ejected droplet into the pressure chamber 23. This causes part of the ejected droplet to fall onto the heater 15. Because part of the cold ejected droplet falls onto the heater 15 which has been heated to a high temperature for film boiling, a drastic temperature change occurs, which appears as the aforementioned characteristic point. Detecting the presence of this characteristic point enables determination of normal ejection.

As thus described, the determination can be made only by ejection without printing a test pattern on a print medium, which advantageously does not require a print medium where ejected droplets land. Because there is no need to print on a print medium, for example, droplets may be ejected to a cap or the like provided at the printing apparatus 1100 to prevent drying of ink from the nozzles of the liquid ejection head 3.

In this way, the present embodiment determines whether ink is circulating normally not by printing a test pattern on a print medium, but by driving the heaters 15, ejecting ink from the ejection ports 13, and determining the state of the ejection. Thus, a pressure sensor does not need to be provided in the circulation path. Thus, the present embodiment can provide a liquid ejection apparatus and a testing method capable of detecting whether ink circulation flow is normal, while achieving size reduction and cost reduction.

### Third Embodiment

A third embodiment of the present disclosure is described below with reference to the drawings. Note that the following describes configurations characteristic to the present embodiment because the present embodiment has the same basic configuration as the first embodiment.

In the embodiments described above, ejection for the circulation testing is performed with an output for the first circulation pump (hereinafter also referred to simply as a pump) 1002 being lowered from the output Pp for regular printing to Pt. In the present embodiment, an output for the pump 1002 is set to Pta which is lower than Pp, determines whether ink is ejected normally, sets the pump output to Ptb lower than Pta in a case where ink is ejected normally, and determines whether ink is ejected normally. In other words, the circulation testing is performed while lowering the pump output in a plurality of stages from the output for regular printing.

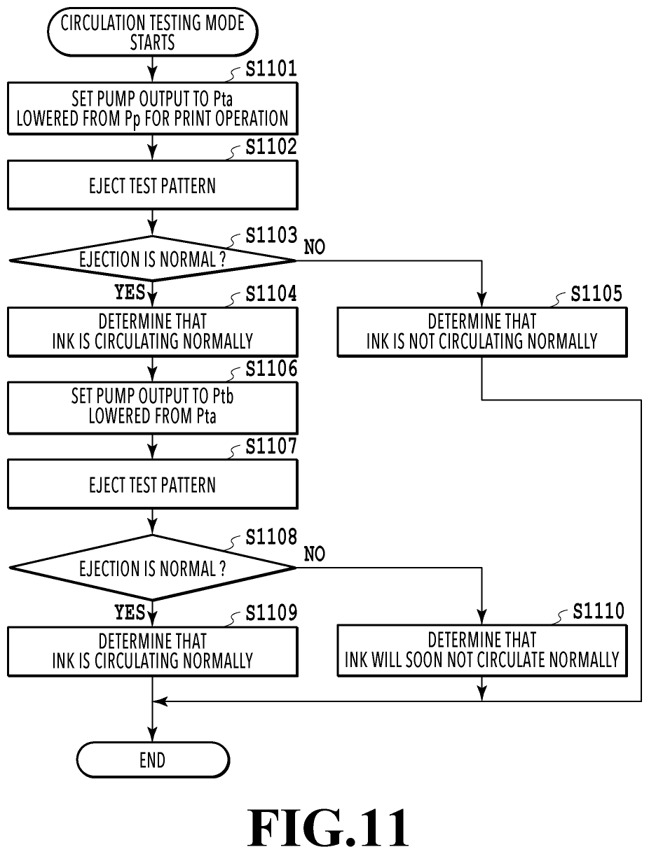

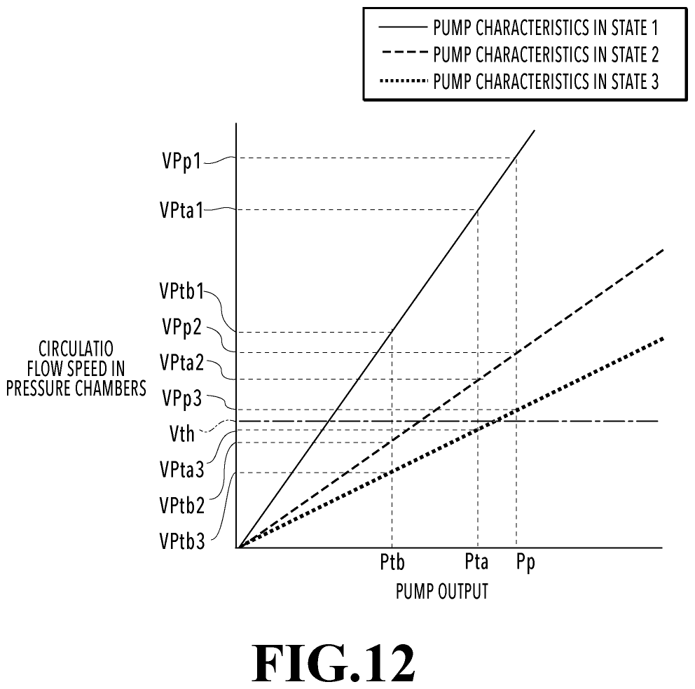

FIG. 11 is a flowchart showing circulation testing processing in the present embodiment. The series of processing steps shown in FIG. 11 are performed by the CPU 30a of the printing apparatus 1100 by loading program code stored in the ROM 30c into the RAM 30b and executing the program code. Alternatively, some or all of the functions in the steps in FIG. 11 may be implemented by hardware such as an ASIC or an electronic circuit. Note that the letter “S” in the description of each processing means that it is a step in the flowchart. FIG. 12 is a graph showing the relation between circulation flow speed and pump output for a state 1 of normal circulation, a state 2 after a given period of usage, and a state 3 after another given period of usage.

In the state 1, for all of the pump outputs for the pump 1002, namely Pp for printing, Pta lowered from Pp, and Ptb lowered further from Pta, the respective circulation flow speeds (VPp1, VPta1, VPtb1) in the pressure chambers 23 are higher than a minimum circulation flow speed Vth for achieving desired printing. In this state, the relation of the outputs for the pump 1002 is Pp>Pta>Ptb.

In the state 2, which is after a given period of usage has passed since the state 1 and in which the circulation flow speed has decreased, at the output Pp of the pump 1002 for printing, Pta lowered from Pp, and Ptb lowered further from Pta, the circulation flow speeds in the pressure chambers 23 are VPp2, VPta2, and VPtb2, respectively. Then, the relation of the circulation flow speeds is VPp2>VPta2>Vth>VPtb2.

In the state 2, the circulation flow speed VPta at the output Pta lowered from Pp is VPta>Vth, and it can therefore be determined that ink is circulating normally. However, at the output Ptb lowered further from Pta, Vth>VPtb2, i.e., the circulation flow speed VPtb2 is lower than the minimum circulation flow speed Vth, and it can therefore be determined that ink will soon not circulate normally.

Upon detection of such a state, an estimate is made of how much longer normal printing can be performed. This makes it possible to perform a recovery operation at appropriate timing and optimize the number of recovery operations so as to shorten the period of time printing is halted for recovery operations. For the estimation, tests are conducted beforehand for the first circulation pump 1002 and the liquid ejection head 3 to obtain the time it takes to achieve normal printing and the degree of recovery by recovery processing. An optimal number of recovery operations can thus be obtained.

In the state 3, which is after a given period of usage has passed since the state 2 and in which the circulation flow speed has decreased further, at the output Pp for the pump 1002 for printing, Pta lowered from Pp, and Ptb lowered further from Pta, the circulation flow speeds in the pressure chambers 23 are VPp3, VPta3, and VPtb3, respectively. Then, the relation of the circulation flow speeds is VPp3>Vth>VPta3>VPtb3.

In the state 3, the circulation speed VPta3 at the output Pta lowered from Pp is already lower than the minimum circulation flow speed (Vth>VPta3). This means that ink is not circulating normally and that a recovery operation needs to be performed immediately.

Once the circulation testing shown in FIG. 11 starts, in S1101, an output for the pump 1002 is lowered to Pta from the output Pp for regular printing by the printing apparatus 1100. With the output for the pump 1002 being lowered, in S1102, ink droplets are ejected based on a test pattern. After that, in S1103, it is determined using an optical sensor whether the ink droplets are ejected normally. If it is determined that the ink droplets are ejected normally (YES), the processing proceeds to S1104 and determines that ink is circulating normally. If it is determined that the ink droplets are not ejected normally (NO), the processing proceeds to S1105 to determine that ink is not circulating normally. After S1104, the processing proceeds to S1106 to lower the output for the pump 1002 from Pta to Ptb. In S1107, ink droplets are ejected based on a test pattern. After that, in S1108, it is determined using the optical sensor whether the ink droplets are ejected normally. If it is determined that the ink droplets are ejected normally (YES), the processing proceeds to S1109 to determine that ink is circulating normally and end the processing. If it is determined that the ink droplets are not ejected normally (NO), the processing proceeds to S1110 to determine that ink will soon not circulate normally and end the processing.

In this way, the pump output is lowered and changed in two stages in circulation testing mode. This makes it possible not only to detect whether ink is circulating normally, but also to predict whether ink will soon not circulate normally.

Although changed in two stages in the present embodiment, the pump output may be changed in more than two stages, such as three or four stages. With more stages, ink circulation state can be tracked in more detail. Also, a different level of recovery processing may be executed depending on a determination result.

In the example described in the present embodiment, like in the second embodiment that detects ejection, the determination of normal ejection is made using an optical sensor or a temperature detection element; however, the determination of normal ejection may be made visually or the like based on a test pattern printed on a print medium like in the first embodiment. In that case, it is time-consuming to make the determination based on a test pattern after every change in the output for the pump 1002 like in FIG. 11. Thus, after all the test patterns are printed while the output for the pump 1002 is changed in several stages, finally, the plurality of test patterns may be determined visually or the like as to their states of droplet landing.

In this way, the present embodiment sets the pump output to Pta lowered from Pp and determines whether droplets are ejected normally. In a case where the droplets are ejected normally, the pump output is set to Ptb lowered from Pta, and it is determined whether droplets are ejected normally. Thus, the present embodiment can provide a liquid ejection apparatus and a testing method capable of detecting whether ink circulation flow is normal, while achieving size reduction and cost reduction by not providing a pressure sensor in the circulation path.

### Modification

A modification of the third embodiment is described below. In the embodiments described above, in circulation testing, the output for the pump 1002 is not set to a value which is equal to or greater than the output Pp for printing. However, for example, in a case where it is determined that the circulation state is the state 2 or 3 in the third embodiment and is still the state 2 or 3 even after a recovery operation is performed, second circulation testing may be carried out with the pump output being set to Ptc larger than the output Pp for printing. In a case where setting the pump output to Ptc leads to a change such that the state 2 changes closer to the state 1 or the state 3 changes closer to the state 2, an operation is performed based on that result to change the setting of the pump output for printing from Pp to Ptc.

By thus appropriately changing the setting of the pump output for printing, the pump 1002 and the liquid ejection head 3 can be used longer, which possibly means longer lives of the pump 1002 and the liquid ejection head 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210889 filed Dec. 14, 2023, which is hereby incorporated by reference wherein in its entirety.

What is claimed is:

1. A liquid ejection apparatus comprising:
a print unit that performs printing by ejecting liquid from an ejection port;
a pump that circulates the liquid to be supplied to the ejection port; and
a control unit that controls driving of the print unit and the pump, wherein
in a print operation for printing an image on a print medium, the control unit drives the pump using a first output, and
in circulation testing for testing a circulation state of the liquid, the control unit drives the pump using a second output with which a smaller amount of liquid is delivered than with the first output.

2. The liquid ejection apparatus according to claim 1, wherein
the output for driving the pump is a voltage applied to a motor.

3. The liquid ejection apparatus according to claim 1, wherein
the output for driving the pump is at least one of a voltage applied to a piezoelectric element and a frequency applied to the piezoelectric element.

4. The liquid ejection apparatus according to claim 1, wherein
in the circulation testing, the control unit drives the print unit while driving the pump using the second output, and
the liquid ejection apparatus comprises a determination unit that determines the circulation state of the liquid based on an ejection state of ejection performed by the print unit.

5. The liquid ejection apparatus according to claim 4, wherein
the determination unit determines the circulation state based on the ejection state obtained from a test pattern printed on a print medium.

6. The liquid ejection apparatus according to claim 5, comprising a unit that reads the test pattern printed on the print medium.

7. The liquid ejection apparatus according to claim 5, comprising a unit that receives a result obtained by a user visually checking the test pattern printed on the print medium.

8. The liquid ejection apparatus according to claim 4, wherein
the determination unit determines the circulation state based on the ejection state obtained by a sensor detecting the liquid ejected by the print unit.

9. The liquid ejection apparatus according to claim 8, wherein
the sensor is an optical sensor.

10. The liquid ejection apparatus according to claim 4, wherein
the determination unit determines the circulation state based on the ejection state detected by a temperature detection element provided at an ejection element of the print unit.

11. The liquid ejection apparatus according to claim 4, wherein
in the circulation testing, the control unit drives the print unit while driving the pump using the second output and then drives the print unit while driving the pump using a third output smaller than the second output.

12. The liquid ejection apparatus according to claim 1, wherein
in a print operation after the circulation testing, the control unit drives the print unit while driving the pump using an output larger than the first output.

13. The liquid ejection apparatus according to claim 4, wherein
based on a result of determination by the determination unit, a recovery operation is performed for a circulation path including the ejection port.

14. A testing method for testing circulation of liquid in a liquid ejection apparatus including
a print unit that performs printing by ejecting liquid from an ejection port and
a pump that circulates the liquid to be supplied to the ejection port, the testing method comprising:
in circulation testing for testing a circulation state of the liquid, driving the pump so that a smaller amount of liquid is delivered than in a print operation for printing an image on a print medium.
